(19) United States
(12) Patent Application Publication
(10) Pub. No.: US 2024/0265698 A1
(43) Pub. Date: Aug. 8, 2024

(54) DRONE-BASED GRID-ASSET INSPECTION

(71) Applicant: DUKE ENERGY CORPORATION, Charlotte, NC (US)

(72) Inventors: Norvin Clontz, II, Charlotte, NC (US); Huiwen Pang, Charlotte, NC (US); Saurabh Patil, Belmont, NC (US); Naveen Barnabas, Charlotte, NC (US); Matthew Orr, Brooklyn, NY (US)

(21) Appl. No.: 18/496,185

(22) Filed: Oct. 27, 2023

Related U.S. Application Data
(60) Provisional application No. 63/483,455, filed on Feb. 6, 2023.

(51) Int. Cl. G06V 20/17; G06F 16/23; G06F 16/29; G06V 10/764; G06V 20/10

(52) U.S. Cl. CPC G06V 20/17; G06F 16/23; G06F 16/29; G06V 10/764; G06V 20/176

(57) ABSTRACT

Methods of drone-based grid-asset inspection are provided. A method of drone-based inspection of an overhead asset of an electrical grid, according to some embodiments, includes flying a drone toward the overhead asset. The method includes capturing, via the drone, a plurality of digital images of the overhead asset. The method includes identifying, using computer vision with respect to the digital images, the overhead asset. Moreover, the method includes updating a geographic information system (GIS) database in response to identifying the overhead asset.

### RELATED APPLICATION

This application claims the benefit of and priority to U.S. Provisional Patent Application No. 63/483,455 filed Feb. 6, 2023, the disclosure of which is incorporated herein by reference as if set forth in its entirety.

### FIELD

The present disclosure relates to inspection of components of electrical grids.

### BACKGROUND

One approach for inspection of assets of an electrical grid is to capture a high volume of images of the assets. For example, images of various distribution poles of the electrical grid can be captured, and these images can be distributed and reviewed manually for each distribution pole. This manual approach, however, may require workers who review images to have domain knowledge of distribution poles, line devices, and their attributes, and may be prone to errors.

### SUMMARY

A method of drone-based inspection of an overhead asset of an electrical grid, according to some embodiments, may include flying the drone toward the overhead asset. The method may include capturing, via the drone, a plurality of digital images of the overhead asset. The method may include identifying, using computer vision with respect to the digital images, the overhead asset. Moreover, the method may include updating a geographic information system (“GIS”) database in response to identifying the overhead asset.

### BRIEF DESCRIPTION OF THE DRAWINGS

FIG. 1A is a schematic illustration of a portion of an electrical grid that includes multiple distribution poles.

FIG. 1B is a block diagram of the drone of FIG. 1A.

FIG. 1C is a block diagram of the node of FIG. 1A.

FIG. 1D is a block diagram that illustrates details of the processor and memory of FIGS. 1B and 1C.

FIG. 1E is a schematic illustration of a room of an office (or data center) of FIG. 1A.

FIG. 2A is a schematic front view of the first distribution pole of FIG. 1A.

FIG. 2B is a schematic front view of the first and second distribution poles of FIG. 1A.

FIG. 2C is a schematic illustration of a drone-captured digital image of assets that are on the first distribution pole of FIGS. 2A and 2B.

FIGS. 3A-3G are flowcharts of operations of drone-based inspection of an overhead asset of the electrical grid of FIG. 1A.

### DETAILED DESCRIPTION

Pursuant to embodiments of the present invention, methods of drone-based grid-asset inspection are provided. The methods may use one or more machine-learning (i.e., artificial-intelligence (“AI”) including computer-vision) models to automatically detect grid assets (e.g., distribution line devices) from drone images, filter out unwanted information from the images, and/or classify grid assets (and/or their corresponding attributes) that are visible in the images. By contrast, conventional operations of reviewing images of grid assets may rely on manual analysis of images by human workers, and thus may require the workers to have detailed knowledge of grid assets and may be prone to human error.

Example embodiments of the present invention will be described in greater detail with reference to the attached figures.

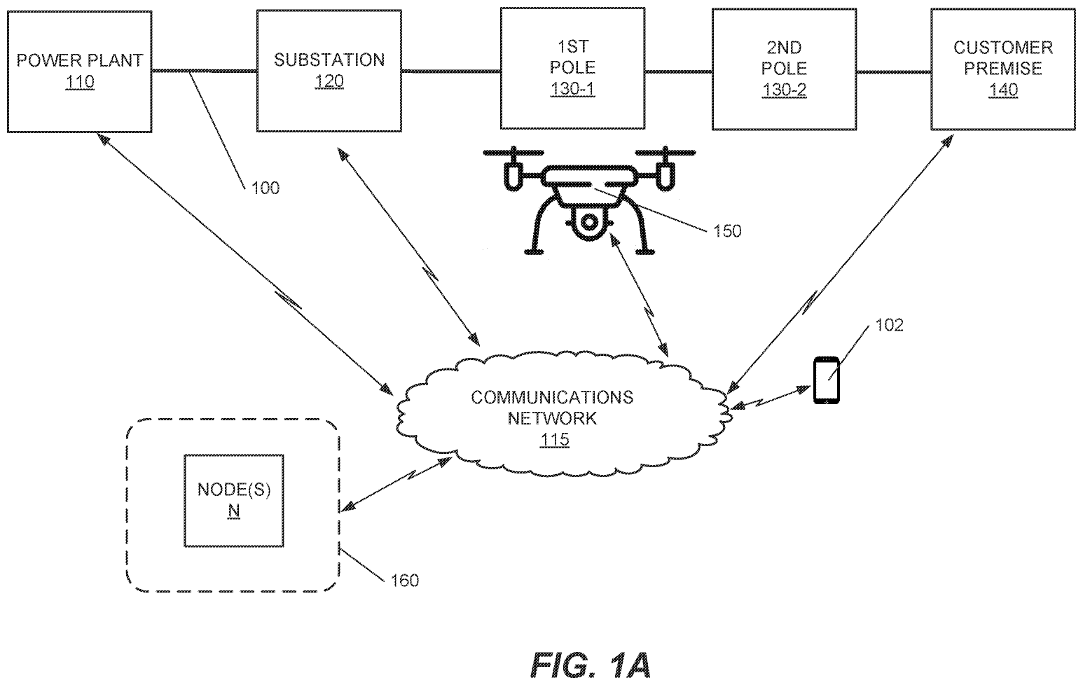

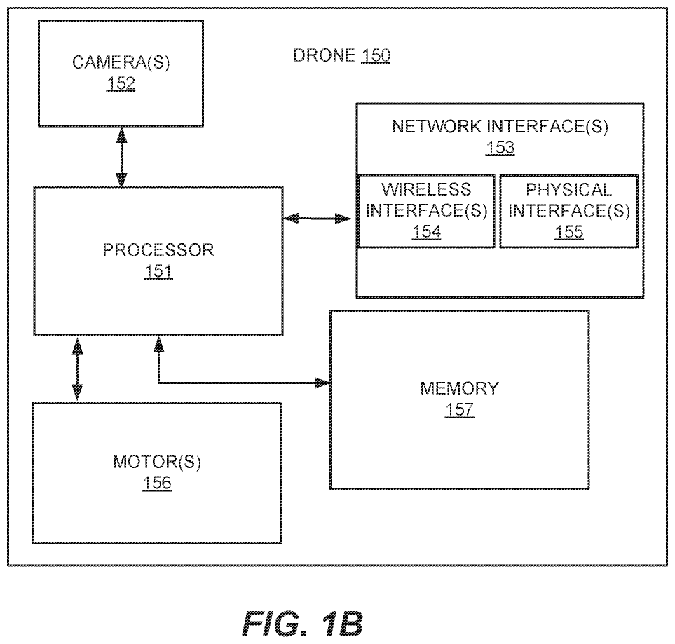

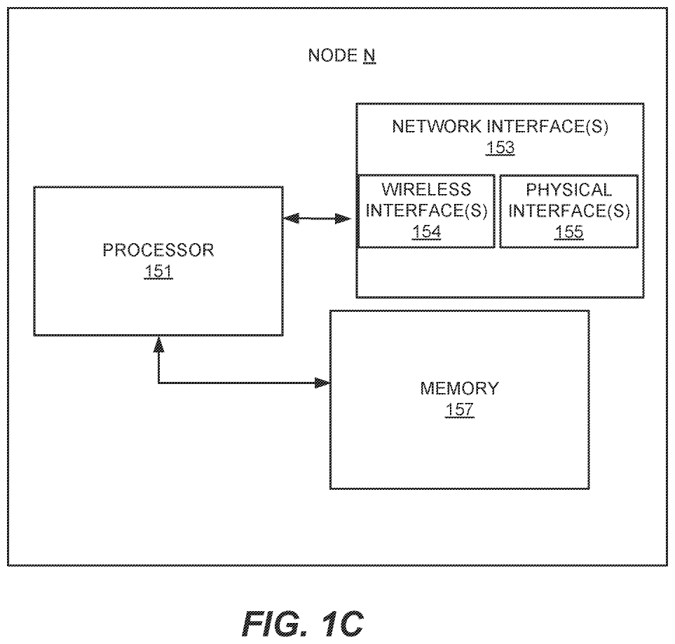

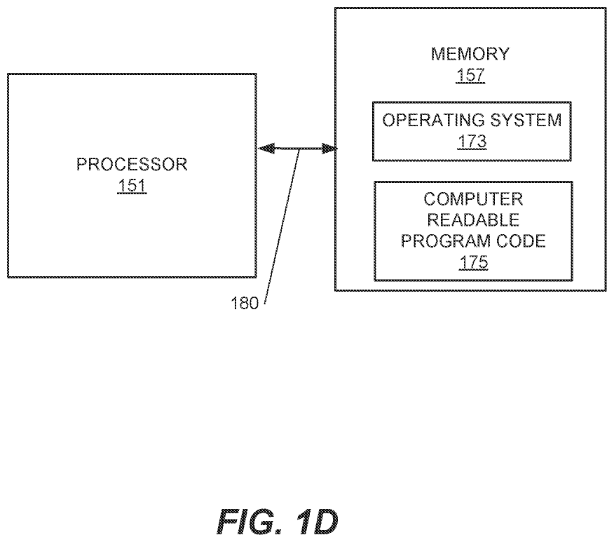

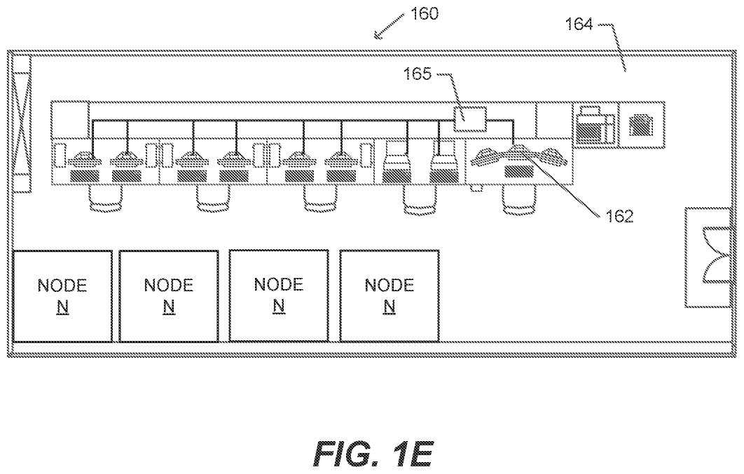

FIG. 1A is a schematic illustration of a portion of an electrical grid 100 that includes multiple distribution poles 130. The grid 100 includes a power plant 110, a substation 120, and first and second distribution poles 130-1, 130-2 that are coupled between the substation 120 and a customer premise 140. The customer premise 140 may comprise the premises of a residential or commercial customer of an electric utility. In some embodiments, the grid 100 may be connected to many customers of the electric utility. For simplicity of illustration, however, only a single customer premise 140 is shown in FIG. 1A.

The power plant 110 may be, for example, a fossil-fuel power plant, a solar power plant, a nuclear power plant, or a hydroelectric power plant. The grid 100 may include a high-voltage (e.g., 46, 69, 115, or 230 kilovolts (“kV”) or higher) portion that connects the power plant 110 to the substation 120 via transmission lines and may be referred to herein as a “transmission network.” Moreover, the grid 100 may include another portion that couples the substation 120 to the customer premise 140, has a lower voltage (e.g., 4.6-33 kV) than the transmission network, and may be referred to herein as a “distribution network.”

The first and second distribution poles 130-1, 130-2 are part of the distribution network. For simplicity of illustration, only two distribution poles 130 are shown in FIG. 1A. According to some embodiments, however, the distribution network may include more (e.g., three, four, dozens, or more) distribution poles 130. The distribution poles 130 may be more broadly referred to herein as “utility poles.” In some embodiments, the transmission network may also include utility poles and/or may include transmission towers. For simplicity of illustration, however, utility poles and transmission towers are omitted from view in the transmission network portion of FIG. 1A.

An unmanned aerial vehicle (“UAV”), which may also be referred to herein as a “drone” 150, may be used to inspect the distribution network and/or the transmission network. As an example, the drone 150 may capture digital images of the first and/or second distribution poles 130-1, 130-2 of the distribution network, and/or may capture digital images of utility poles and/or transmission towers of the transmission network.

The power plant 110, substation 120, customer premise 140, and/or drone 150 may, in some embodiments, communicate with one or more nodes N (e.g., servers) at a data center (or office) 160 and/or with a portable electronic device 102. For example, the communications may occur via a communications network 115, which may include one or more wireless or wired communications networks, such as a local area network (e.g., Ethernet or Wi-Fi), a cellular network, a power-line communication (“PLC”) network, and/or a fiber (such as a fiber-optic) network. The electronic device 102 may be provided at various locations, and may comprise a desktop computer, a laptop computer, a tablet computer, and/or a smartphone.

FIG. 1B is a block diagram of the drone 150 of FIG. 1A. The drone 150 may include a processor 151, one or more cameras 152, one or more network interfaces 153, one or more motors 156, and a memory 157. The processor 151 may be configured to communicate with a node N (FIG. 1A), the communications network 115 (FIG. 1A), and/or the portable electronic device 102 (FIG. 1A) via the network interface(s) 153. Moreover, the processor 151 may be configured to control the camera(s) 152 and/or the motor(s) 156.

The network interface(s) 153 may include one or more wireless interfaces 154 and/or one or more physical interfaces 155. The wireless interface(s) 154 may comprise wireless communications circuitry, such as BLUETOOTH® circuitry, cellular communications circuitry that provides a cellular wireless interface (e.g., 4G/5G/LTE, other cellular), and/or Wi-Fi circuitry. The physical interface(s) 155 may comprise wired communications circuitry, such as wired Ethernet, serial, and/or USB circuitry.

The camera(s) 152 are configured to capture digital images, including digital still images and/or digital video images. Moreover, the motor(s) 156 may be electric motors, such as brushless and/or brushed direct current (“DC”) motors. In some embodiments, each motor 156 may be configured to rotate a respective propeller of the drone 150. For example, the drone 150 may have two, four, or more motors 156 and two, four, or more propellers.

FIG. 1C is a block diagram of the node N of FIG. 1A. The node N may include a processor 151, one or more network interfaces 153, and a memory 157. For simplicity of description, details of the processor 151, the network interface(s) 153, and the memory 157, which are described herein with respect to FIG. 1B, will not be repeated herein with respect to the node N.

FIG. 1D is a block diagram that illustrates details of the processor 151 and memory 157 of FIGS. 1B and 1C that may be used in accordance with various embodiments. The processor 151 communicates with the memory 157 via an address/data bus 180. The processor 151 may be, for example, a commercially available or custom microprocessor. Moreover, the processor 151 may include multiple processors. The memory 157 may be a non-transitory computer readable storage medium and may be representative of the overall hierarchy of memory devices containing the software and data used to implement various functions of a drone 150 (FIGS. 1A and 1B) or a node N (FIGS. 1A and 1C) as described herein. The memory 157 may include, but is not limited to, the following types of devices: cache, ROM, PROM, EPROM, EEPROM, flash, static RAM (“SRAM”), and dynamic RAM (“DRAM”).

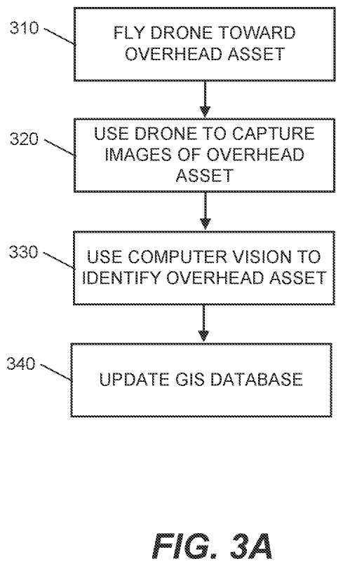

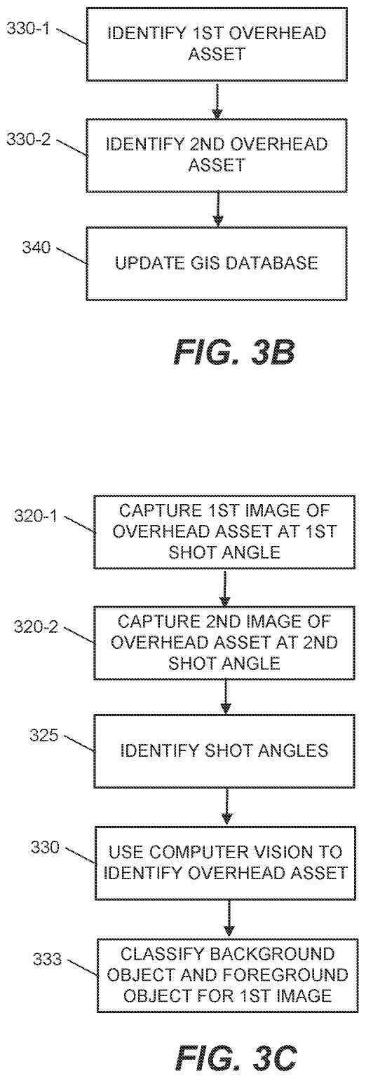

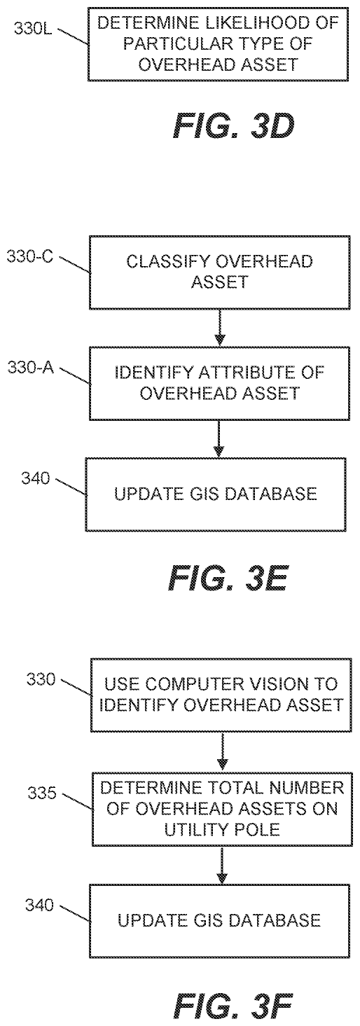

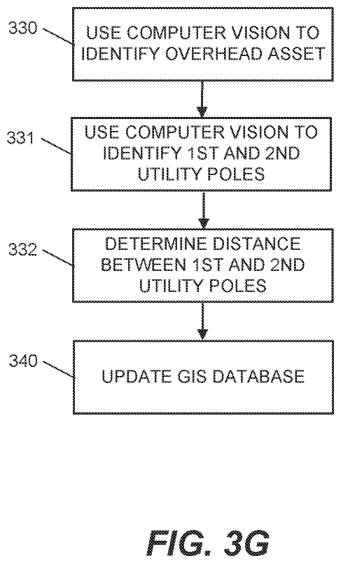

As shown in FIG. 1D, the memory 157 may hold various categories of software and data, such as computer readable program code 175 and/or an operating system 173. The operating system 173 controls operations of a drone 150 or a node N. In some embodiments, the operating system 173 may manage the resources of the drone 150 or the node N and may coordinate execution of various programs by the processor 151. For example, the computer readable program code 175, when executed by a processor 151 of the drone 150 or the node N, may cause the processor 151 to perform operations illustrated in the flowcharts of FIGS. 3A-3G. As an example, operations of Blocks 310 and 320 in the flowchart of FIG. 3A may be performed by the drone 150 and operations of Blocks 330 and 340 in the flowchart of FIG. 3A may be performed by the node N.

FIG. 1E is a schematic illustration of a room 164 of an office (or data center) 160 of FIG. 1A. The room 164 may include one or more nodes N that may communicate via a communications network 115 (FIG. 1A) with the drone 150 (FIG. 1A) and/or components of the grid 100 (FIG. 1A). The room 164 may also include one or more electronic devices 162 that can communicate with the node(s) N in the room 164 via a local area network (“LAN”) 165. Additionally or alternatively, an electronic device 162 may communicate via the LAN with one or more nodes N that are in a different room of the data center 160. In some embodiments, the LAN 165 may comprise a wired and/or wireless (e.g., Wi-Fi) Ethernet network that connects electronic devices 162 that are inside the data center 160 (a) to each other, (b) to nodes N that are inside the data center 160, and/or (c) to the communication network 115. The electronic devices 162 may comprise desktop computers, laptop computers, tablet computers, and/or smartphones. Accordingly, a human user, such as an electric utility employee or contractor, may provide user inputs to an electronic device 162 to communicate with one or more nodes N that are inside the data center 160 (and/or to communicate with one or more nodes N that are outside of the data center 160).

Though four nodes N are shown in FIG. 1E, the data center 160 may include one, two, three, five, or more nodes N. Moreover, the nodes N that are inside the data center 160 may, in some embodiments, be respective servers that can each host one or more machine-learning (and/or business-logic) models. Accordingly, a human user may use an electronic device 162 to provide inputs to the machine-learning model(s) and/or to receive outputs from the machine-learning model(s).

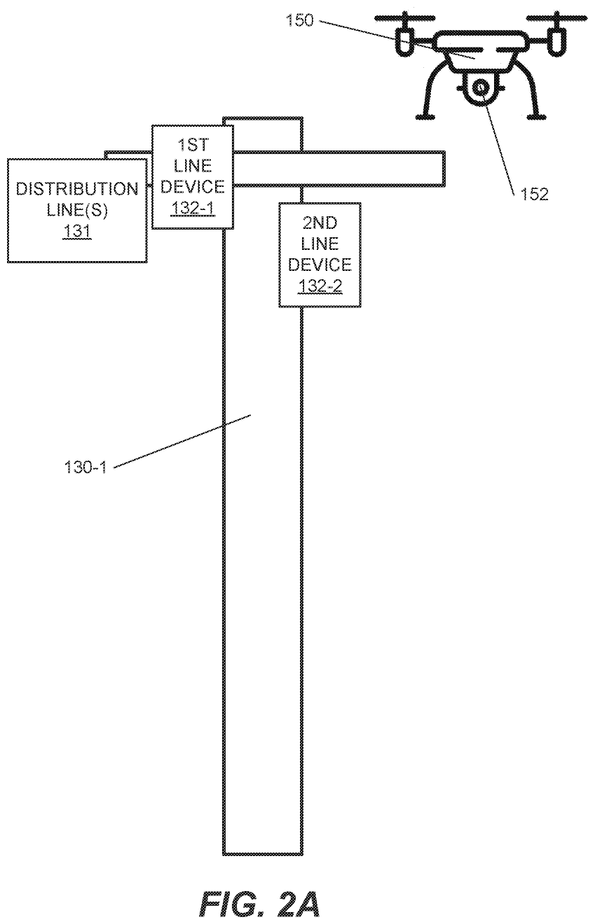

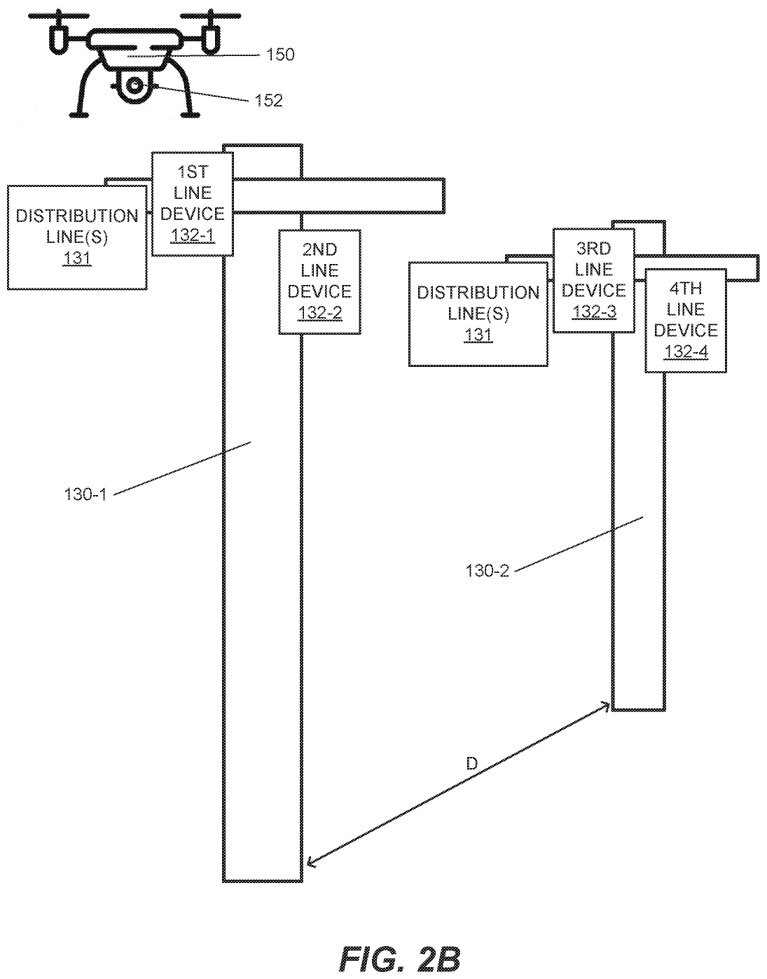

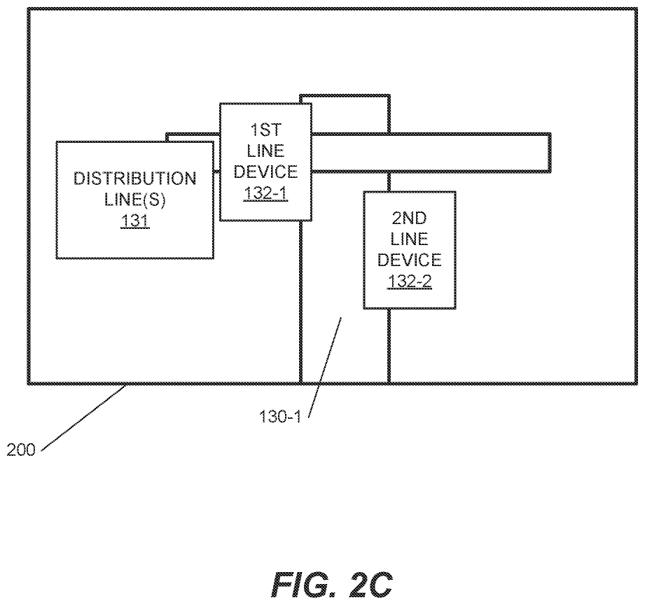

FIG. 2A is a schematic front view of the first distribution pole 130-1 of FIG. 1A. As shown in FIG. 2A, the drone 150 can fly in the air above and/or near the top of the first distribution pole 130-1. As a result, camera(s) 152 of the drone 150 can capture various digital images of one or more overhead assets of the grid 100 (FIG. 1A) that are on the first distribution pole 130-1.

The overhead asset(s) may include, for example, one or more distribution lines 131 that are supported by the first distribution pole 130-1 and/or one or more distribution line devices 132 that are supported by the first distribution pole 130-1. Examples of distribution line devices 132 include transformers, regulators, reclosers, capacitors, line sensors, primary meters, fuses, switches, and sectionalizers. In some embodiments, the distribution line devices 132 may include first and second distribution line devices 132-1, 132-2, which may be the same type of distribution line device or different types of distribution line devices. As an example, the first distribution line device 132-1 may be a fuse and the second distribution line device 132-2 may be a transformer, or the first and second distribution line devices 132-1, 132-2 may be respective fuses or respective transformers.

FIG. 2B is a schematic front view of the first and second distribution poles 130-1, 130-2 of FIG. 1A. The first and second distribution poles 130-1, 130-2 may be spaced apart from each other by a distance D (e.g., a horizontal distance). The second distribution pole 130-2 may support one more overhead assets of the grid 100 (FIG. 1A). For example, the second distribution pole 130-2 may support one or more distribution lines 131, a third distribution line device 132-3, and/or a fourth distribution line device 132-4.

According to some embodiments, the camera(s) 152 of the drone 150 may capture a digital image (or multiple digital images) including both the first distribution pole 130-1 and the second distribution pole 130-2. As an example, the drone 150 may be positioned as shown in FIG. 2B such that the first distribution pole 130-1 is in the foreground of a digital image captured by camera(s) 152 of the drone and the second distribution pole 130-2 is in the background of the digital image. The first and second distribution line devices 132-1, 132-2 that are on the first distribution pole 130-1 may thus be foreground objects in the digital image, while the third and fourth distribution line devices 132-3, 132-4 that are on the second distribution pole 130-2 may be background objects in the digital image.

FIG. 2C is a schematic illustration of a drone-captured digital image 200 of assets 131, 132 that are on the first distribution pole 130-1 of FIGS. 2A and 2B. The image 200 may be, for example, a still image captured by camera(s) 152 of the drone 150 (FIGS. 2A and 2B) or a frame of a digital video captured by the camera(s) 152. As shown in FIG. 2C, the image 200 includes an upper portion of the first distribution pole 130-1, and further includes distribution line(s) 131 and first and second distribution line devices 132-1, 132-2 that are on the upper portion of the first distribution pole 130-1.

For simplicity of illustration, only one digital image is shown in FIG. 2C. In some embodiments, however, the camera(s) 152 can capture a plurality of digital images of the distribution line(s) 131, the first distribution line device 132-1, and/or the second distribution line device 132-2. For example, the image 200 that is shown in FIG. 2C may be a first digital image that is taken (i.e., captured by the camera(s) 152) at a first shot angle, and a second digital image of the upper portion of the first distribution pole 130-1 may be taken at a second shot angle of the camera(s) 152 that is different from the first shot angle. As an example, the first and second digital images may be taken in front of, from the side of, and above/on top of, respectively, the upper portion of the first distribution pole 130-1. In another example, the first and second digital images may be taken in front of and behind, respectively, the upper portion of the first distribution pole 130-1. Moreover, the camera(s) 152 may capture three, four, or more digital images of the first distribution pole 130-1 at respective shot angles, according to some embodiments.

FIGS. 3A-3G are flowcharts of operations of drone-based inspection of an overhead asset 131 (or 132) (FIG. 2B) of an electrical grid 100 (FIG. 1A). Referring to FIG. 3A, the operations include flying (Block 310), such as by remote control via a human operator in possession of a portable electronic device 102 (FIG. 1A) and/or via a communications network 115 (FIG. 1A) or other communications link, a drone 150 (FIG. 1A) toward the overhead asset 131 (or 132). As an example, the drone 150 may fly away from the portable electronic device 102 and toward a first distribution pole 130-1 (FIG. 2A) having the overhead asset 131 (or 132) thereon.

The drone 150 can capture (Block 320), via camera(s) 152 (FIG. 1B) thereof, a plurality of digital images 200 (FIG. 2C) of the overhead asset 131 (or 132) while the drone 150 flies adjacent (e.g., flies in a loop around) the overhead asset 131 (or 132). For example, two to twelve (2-12) images 200 may be captured of the first distribution pole 130-1 having the overhead asset 131 (or 132) thereon. In other embodiments, only one digital image 200 may be captured of the first distribution pole 130-1.

In some embodiments, the drone 150 may be within 100 feet of the overhead asset 131 (or 132) when the drone 150 captures the images 200. As an example, the images 200 may be captured when the drone 150 is no more than 50 feet (or no more than 25 feet) away from the overhead asset 131 (or 132). Moreover, the drone 150 may capture one or more of the images 200 while the drone 150 is flying at a vertical level/height that is above a vertical level/height of the overhead asset 131 (or 132). The images 200 may be respective still images that are captured by the camera(s) 152 or respective frames of a digital video that is captured by the camera(s) 152.

The overhead asset 131 (or 132) may be identified (Block 330) by using computer vison with respect to the images 200. For example, a node N (FIG. 1A) may receive the images 200 and use computer vision to identify the asset 131 (or 132) as a particular type of asset, such as a distribution line 131, a transformer, a regulator, a recloser, a capacitor, a line sensor, a primary meter, a fuse, a switch, or a sectionalizer. Accordingly, computer vision can distinguish a distribution line 131 from a distribution line device 132 and can distinguish different types of distribution line devices 132 (e.g., a transformer vs. a fuse) from each other. In some embodiments, the node N may receive the images 200 via the communications network 115 and/or via another medium, such as a USB flash drive or a memory card that was present on the drone 150 when the camera(s) 152 captured the images 200.

In response to identifying the overhead asset 131 (or 132), a GIS database may be updated (Block 340). As an example, the node N may update (e.g., edit) the GIS database by (a) providing information regarding the overhead asset 131 (or 132) to the GIS database for the first time or (b) editing an existing entry in the GIS database regarding the overhead asset 131 (or 132). For example, the node N may provide data to the GIS database that indicates (i) whether the overhead asset 131 (or 132) is a distribution line 131 or a distribution line device 132, (ii) that the overhead asset 131 (or 132) is a particular type of distribution line device 132, (iii) a geographic position/location of the overhead asset 131 (or 132), (iv) an attribute (e.g., open vs. closed or insulated vs. uninsulated) of the overhead asset 131 (or 132), and/or (v) a time/date that the camera(s) 152 captured the overhead asset 131 (or 132). According to some embodiments, the GIS database may include GIS data about a distribution network of the grid 100 and/or GIS data about a transmission network of the grid 100. Moreover, the GIS database may be hosted by the node N and/or by one or more servers outside of the node N.

In some embodiments, the geographic position/location of the overhead asset 131 (or 132) may include coordinates of the geographic position/location of the overhead asset 131 (or 132) and/or may include an identification of a distribution pole 130 that the overhead asset 131 (or 132) is on. Moreover, updating the GIS database may result in updating a list and/or map of the grid 100 that may be displayed via a graphical user interface (“GUI”) (e.g., on the portable electronic device 102 and/or an electronic device 162 (FIG. 1E)) with respect to the overhead asset 131 (or 132). Accordingly, the overhead asset 131 (or 132) may be displayed for the first time on the list/map, or new information about (e.g., an updated status/attribute of) the overhead asset 131 (or 132) may be displayed on the list/map. As an example, the node N may confirm that the overhead asset 131 (or 132) remains on a particular distribution pole 130 (and/or at a particular geographic position/location) that was previously recorded in the GIS database with respect to the overhead asset 131 (or 132) and/or may provide to the GIS database a date/time that the camera(s) 152 most recently captured the overhead asset 131 (or 132) on the distribution pole 130.

As shown in FIG. 3B, operations of identifying (Block 330 of FIG. 3A) the overhead asset 131 (or 132) may include using computer vision with respect to images 200 from the camera(s) 152 to identify (Block 330-1) a first overhead asset 131 (or 132) and to identify (Block 330-2) a second overhead asset 131 (or 132). For example, computer vision may distinguish between two overhead assets 131 (or 132) that are on the same distribution pole 130 or on respective distribution poles 130. A GIS database may be updated (Block 340) in response to identifying the first and second overhead assets 131 (or 132). Moreover, the first and second overhead assets 131 (or 132) may be (i) respective distribution lines 131, (ii) respective distribution line devices 132, or (iii) a distribution line 131 and a distribution line device 132, respectively.

As shown in FIG. 3C, operations of capturing (Block 320 of FIG. 3A) the images 200 may include using the drone 150 to capture (Block 320-1) a first digital image of an overhead asset 131 (or 132) at a first shot angle of the camera(s) 152 and capture (Block 320-2) a second digital image of the overhead asset 131 (or 132) at a second shot angle of the camera(s) 152 that is different from the first shot angle. For example, the second shot angle may result from the drone 150 flying to a different vertical and/or horizontal position from where it was when it captured the first digital image.

According to some embodiments, the first and second shot angles may be identified (Block 325) by the node N (e.g., using computer vision). Computer vision may identify (Block 330) the overhead asset 131 (or 132) in response to capturing the first and second digital images at the respective shot angles and/or in response to identifying the shot angles. Identification of the shot angles can help to improve the accuracy of GIS data (e.g., by facilitating higher-accuracy corrections of inaccurate GIS data).

Moreover, computer vision (e.g., performed by the node N) may classify (Block 333) a background object and a foreground object for the first digital image (and/or for the second digital image). As an example, the overhead asset 131 (or 132) may be on a first distribution pole 130-1 (FIG. 2B), computer vision may classify the overhead asset 131 (or 132) as a foreground object that is in the digital image, and computer vision may classify another overhead asset 131 (or 132) that is on a second distribution pole 130-2 (FIG. 2B) as a background object that is in the digital image. Accordingly, the background object is not on the first distribution pole 130-1. By separating objects into background and foreground objects, computer vision can distinguish between the two different distribution poles 130-1, 130-2.

As shown in FIG. 3D, computer vision (e.g., performed by the node N) may determine (Block 330L) a likelihood that an overhead asset 131 (or 132) is a particular type of overhead asset. For example, computer vision may determine that a first distribution line device 132-1 (FIG. 2A) has a 40% likelihood of being a fuse and/or that a second distribution line device 132-2 (FIG. 2A) has a 68% likelihood of being a transformer. As another example, computer vision may determine a likelihood that an overhead asset 131 (or 132) is a distribution line 131 rather than a distribution line device 132, or vice versa. In some embodiments, respective likelihoods that objects in an image 200 are particular overhead assets, respectively, may be displayed via a GUI (e.g., on the portable electronic device 102 and/or the electronic device 162). Moreover, operation(s) of Block 330L may be performed after (or as a part of) of identifying (Block 330 of FIG. 3A) the overhead asset 131 (or 132) and before updating (Block 340 of FIG. 3A) the GIS database.

As shown in FIG. 3E, operations of identifying (Block 330 of FIG. 3A) the overhead asset 131 (or 132) may include using computer vision with respect to images 200 from the camera(s) 152 to classify (Block 330-C) the overhead asset 131 (or 132) and/or to identify an attribute (Block 330-A) of the overhead asset 131 (or 132). For example, computer vision may classify the overhead asset 131 (or 132) as a fuse and may determine that the fuse is open, closed, gang-operated, or line-disconnected. As another example, computer vision may classify the overhead asset 131 (or 132) as a distribution line 131 and may determine whether the distribution line 131 is insulated. A GIS database may be updated in response to classifying the overhead asset 131 (or 132) and/or identifying an attribute of the overhead asset 131 (or 132).

As shown in FIG. 3F, computer vision (e.g., performed by the node N) may determine (Block 335) a total number of overhead assets 131/132 that are on a particular distribution pole 130. In some embodiments, the determination/calculation of the total number of overhead assets 131/132 may include distribution line devices 132 and exclude distribution lines 131. The GIS database may be updated (Block 340) in response to determining the total number of overhead assets 131/132. For example, the GIS database may be updated to present the total number of overhead assets 131/132 in a list/map of the grid 100 that may be displayed via a GUI (e.g., on the portable electronic device 102 and/or the electronic device 162).

As shown in FIG. 3G, computer vision (e.g., performed by the node N) with respect to the images 200 may identify (Block 331) first and second distribution poles 130-1, 130-2 and determine (Block 332) a distance D (FIG. 2B) between the first and second distribution poles 130-1, 130-2. Moreover, the GIS database may be updated (Block 340) in response to identifying the first and second distribution poles 130-1, 130-2 and/or in response to determining the distance D therebetween. In some embodiments, the distance D may be compared (e.g., by the node N) with recorded geographic positions/locations of the drone 150 when the camera(s) 152 captured different images 200. This can help to improve the accuracy of distinguishing between different (and/or tracking particular) overhead assets that are captured in the images 200.

Methods of drone-based inspection of an overhead asset, such as a distribution line 131 (FIG. 2A) or a distribution line device 132 (FIG. 2A), according to embodiments of the present invention may provide a number of advantages. These advantages include generating highly accurate data for a GIS database by using computer vision with respect to digital images 200 (FIG. 2C) of the overhead asset that are captured by one or more cameras 152 (FIG. 1B) of a drone 150 (FIG. 1A). In contrast, conventional approaches may require manual verification of three-phase conductors (e.g., distribution lines), line devices (e.g., distribution line devices), and attributes thereof. Such manual verification may be unsustainable across an electrical grid that includes a large number of utility poles (e.g., thousands or even millions of utility poles in a state or other geographic region) and may result in inaccurate data due to human error. Accordingly, embodiments of the present invention may improve the quality and sustainability of GIS data generation/verification by using advanced AI/image analytics to identify gaps, recommend corrections of GIS errors, and support updates to the GIS database. Image analytics models can automate the identification, validation, and analysis of three-phase conductors (e.g., to determine wire code) and line devices (including key attributes) of an electrical grid.

Before applying computer vision to the images 200, data analysis and model training (of one or more machine-learning models) may be performed using a large number (e.g., dozens, hundreds, thousands, or more) of digital images of overhead assets and classification/attribute data regarding the overhead assets. Though most entities may lack sufficient knowledge and/or data sets to accurately predict/classify overhead assets, the inventor(s) of the present invention can train model(s) using sufficient knowledge/data sets to identify even difficult-to-identify three-phase conductors (e.g., distribution lines 131) and/or distribution line devices 132. In some embodiments, more than one hundred thousand (100,000) data points may be used to train the model(s). Moreover, an additional neural network may be used to recognize less-common distribution line devices 132, such as sectionalizers (or switches or other protective devices).

After training, the model(s) can be used to apply computer vision to the images 200. If the model(s) has a high confidence with respect to identification of an overhead asset that is captured in the images 200, then GIS corrections/updates with respect to that overhead asset may be fully automated or semi-automated. On the other hand, if the model(s) has a low confidence with respect to identification of the overhead asset, then GIS corrections/updates may require manual/field validation.

In some embodiments, the model(s) may filter out unwanted information from the images 200. For example, if a capacitor is detected in one or more images 200 on a different distribution pole 130 (FIG. 2B) from a distribution pole 130 (FIG. 2B) that is under inspection/examination, voting logic can remove inferences regarding the capacitor in the images 200 if a foreground/background model misses them.

According to some embodiments, computer vision may perform object association to link/track overhead assets. For example, for a particular distribution pole 130, several images 200 may be captured, and it may be desirable to index the same object (e.g., overhead asset) consistently across the different images 200. Accordingly, the model(s) may define levels based on pole complexity and then may associate objects in the images 200 with those levels.

In some embodiments, the model(s) may identify insulators (e.g., 5.5-inch insulators) and associated three-phase conductors based on the number of visible strands in one or more digital images 200 (e.g., top-view images). Accordingly, it may be desirable to identify the number of strands of the three-phase conductors. Moreover, the model(s) may identify (i) a material (e.g., a type of metal) of the three-phase conductors, (ii) whether the three-phase conductors are insulated, (iii) how many amps the three-phase conductors can carry, and/or (iv) a wire code of the three-phase conductors.

Accordingly, embodiments of the present invention may use drone imagery to provide information about existing grid assets in an accurate and timely manner. For example, an ensemble of machine learning-based models and rule-based approaches can be used to automate the review process of high volumes of images 200 by detecting distribution line devices 132 from the images 200, filtering out unwanted information, and cataloging/recommending assets and their corresponding attributes that are visible from the images 200.

Example embodiments are described herein with reference to the accompanying drawings. Many different forms and embodiments are possible without deviating from the teachings of this disclosure and so the disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of layers and regions may be exaggerated for clarity. Like reference numbers refer to like elements throughout.

It should also be noted that in some alternate implementations, the functions/acts noted in flowchart blocks herein may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the present invention.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein, the term “and/or” includes any and all combinations of one or more of the associated listed items. Moreover, the symbol “/” (e.g., when used in the term “transmission/distribution”) will be understood to be equivalent to the term “and/or.”

It will be understood that although the terms “first,” “second,” etc. may be used herein to describe various elements, these elements should not be limited by these terms. These terms are only used to distinguish one element from another. Thus, a first element could be termed a second element without departing from the teachings of the present embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is turned over, elements described as “below” or “beneath” other elements or features would then be oriented “above” the other elements or features. Thus, the term “below” can encompass both an orientation of above and below. The device may be otherwise oriented (e.g., rotated 90 degrees or at other orientations) and the spatially relative descriptors used herein may be interpreted accordingly.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

Example embodiments of the present invention may be embodied as nodes, devices, apparatuses, and methods. Accordingly, example embodiments of the present invention may be embodied in hardware and/or in software (including firmware, resident software, micro-code, etc.). Furthermore, example embodiments of the present invention may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Example embodiments of the present invention are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create/use circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope is to be determined by the broadest permissible interpretation of the following claims and their equivalents, and shall not be restricted or limited by the foregoing detailed description.

What is claimed is:

1. A method of drone-based inspection of an overhead asset of an electrical grid, the method comprising:
flying a drone toward the overhead asset;
capturing, via the drone, a plurality of digital images of the overhead asset;
identifying, using computer vision with respect to the digital images, the overhead asset; and
updating a geographic information system (GIS) database in response to identifying the overhead asset.

2. The method of claim 1, wherein the digital images comprise:
a first digital image of the overhead asset taken at a first shot angle; and
a second digital image of the overhead asset taken at a second shot angle that is different from the first shot angle.

3. The method of claim 2, further comprising identifying the first and second shot angles.

4. The method of claim 1, wherein the overhead asset comprises a distribution line device.

5. The method of claim 4, wherein the distribution line device comprises a transformer, a regulator, a recloser, a capacitor, a line sensor, a primary meter, a fuse, a switch, or a sectionalizer.

6. The method of claim 1, wherein the overhead asset comprises a transmission line or a distribution line.

7. The method of claim 1, wherein identifying the overhead asset comprises determining a likelihood that the overhead asset is a particular type of overhead asset.

8. The method of claim 1,
wherein the overhead asset comprises a first overhead asset of the electrical grid, and
wherein the method further comprises:
identifying, using computer vision with respect to the digital images, a second overhead asset of the electrical grid; and
updating the GIS database in response to identifying the second overhead asset.

9. The method of claim 8, wherein the first and second overhead assets are different types of overhead assets.

10. The method of claim 1,
wherein identifying the overhead asset comprises classifying the overhead asset, and
wherein the method further comprises identifying, using computer vision with respect to the digital images, an attribute of the overhead asset.

11. The method of claim 10,
wherein classifying comprises determining that the overhead asset comprises a switch, and
wherein identifying the attribute comprises determining one or more of the following: switch normal status, switch size, switch operating mechanism, whether switch is gang-operated.

12. The method of claim 10,
wherein classifying comprises determining that the overhead asset comprises a fuse, and
wherein identifying the attribute comprises determining one or more of the following: fuse normal status, fuse type, fuse size and fuse continuous amp rating.

13. The method of claim 10,
wherein classifying comprises determining that the overhead asset comprises a capacitor, and
wherein identifying the attribute comprises determining one or more of the following: capacitor switch type, capacitor SCADA type, capacitor control type, capacitor sensing phase and sensor location.

14. The method of claim 10,
wherein classifying comprises determining that the overhead asset comprises a recloser, and
wherein identifying the attribute comprises determining one or more of the following: recloser bypass type, recloser bypass size, recloser bypass status, recloser SCADA type, and recloser control type.

15. The method of claim 10,
wherein classifying comprises determining that the overhead asset comprises a regulator, and
wherein identifying the attribute comprises determining one or more of the following: regulator bypass type, regulator bypass size, regulator bypass status, regulator SCADA type, regulator KVA rating, and regulator mounting type.

16. The method of claim 10,
wherein classifying comprises determining that the overhead asset comprises a sectionalizer, and
wherein identifying the attribute comprises determining whether the sectionalizer is open or closed.

17. The method of claim 10,
wherein classifying comprises determining that the overhead asset comprises a transformer, and
wherein identifying the attribute comprises determining one of more of the following: transformer size, transformer KVA, and transformer secondary voltage.

18. The method of claim 10,
wherein classifying comprises determining that the overhead asset comprises a distribution line, and
wherein identifying the attribute comprises determining one or more of the following: conductor wire code, conductor size, conductor material, and whether the distribution line is insulated or stranded.

19. The method of claim 1,
wherein the overhead asset is on a utility pole, and
wherein the method further comprises determining, using computer vision, a total number of overhead assets that are on the utility pole.

20. The method of claim 19, wherein the total number includes distribution line devices and distribution lines.

21. The method of claim 1, further comprising classifying, for a first of the digital images, a background object and a foreground object,
wherein the overhead asset comprises the foreground object and is on a utility pole, and
wherein the background object is not on the utility pole.

22. The method of claim 21, wherein the background object is on another utility pole.

23. The method of claim 1, wherein the digital images comprise respective still images that are captured by one or more cameras of the drone.

24. The method of claim 1, wherein the digital images comprise respective frames of a digital video that is captured by one or more cameras of the drone.

25. The method of claim 1, wherein the GIS database comprises GIS data about a distribution network of the electrical grid.
